(19) United States
(12) Patent Application Publication
(10) Pub. No.: US 2014/0306081 A1
(43) Pub. Date: Oct. 16, 2014

(54) CLAMPING APPARATUS

(71) Applicant: Eagle FAN, Chu-Pei City (TW)

(72) Inventor: Eagle FAN, Chu-Pei City (TW)

(21) Appl. No.: 13/862,659

(22) Filed: Apr. 15, 2013

(51) Int. Cl. F16M 13/02; H04B 1/38

(52) U.S. Cl. CPC F16M 13/02; H04B 1/3888
USPC 248/274.1

(57) ABSTRACT

A clamping apparatus is provided, including a base unit, a clamping unit, at least a stop unit and a retractable unit, wherein the base unit having a placement surface for providing placement of an electronic product, the clamping unit and the stop unit being disposed at the base unit, the clamping unit able to move towards or away from the stop unit so that the electronic product being clamped between the clamping unit and the stop unit, the retractable unit being disposed at the clamping unit, further including a retractable rod and a buckle element, the buckle element being disposed at the tip of the retractable rod, the buckle element being above the clamping unit when the retractable rod extending. As such, when the electronic product is clamped with protective sleeve on, the buckle element can lift the upper cover of protective sleeve to use as a sun-shielding plate.

### FIELD OF THE INVENTION

The present invention generally relates to a clamping apparatus, and more specifically to an apparatus able to clamp an electronic device without separating the electronic device from a protective sleeve and able to view the display on the screen.

### BACKGROUND OF THE INVENTION

Smart phones are a popular portable electronic product nowadays. With large screen and various application programs, the smart phone is not only a phone, but also a media, information and entertainment center. The diverse functions make the smart phone an indispensible item for many people. As the price of a smart phone is relatively high, the user often tries to provide extra protection to the phone, for example, by using a protective sleeve.

A widely popular protective sleeve for smart phone uses a cover-type structure. The protective sleeve mainly includes a fixed base and an upper cover. The fixed base is for carrying the electronic product and the upper cover is flexibly connected to a side of the fixed base and able to cover the fixed base after flipping and folding to protect the screen and the case of the electronic product from scratching. However, for using the electronic product in a protective sleeve inside a car, the electronic product must be separated from the protective sleeve so that the clamping device inside the car can clamp the electronic product without the upper cover blocking the viewing of the screen. Then, when removing the electronic product from the clamping device, the protective sleeve is placed back on, which is inconvenient. As such, it is desirable to devise a clamping device able to clamp an electronic device without separating the electronic device from a protective sleeve and able to view the display on the screen.

### SUMMARY OF THE INVENTION

The primary object of the present invention is to provide a clamping apparatus. The clamping apparatus is disposed with a retractable unit. When the electronic product is sheathed inside a cover-type protective sleeve, the retractable unit is to maintain the upper cover in a lifted position when the clamping apparatus clamps the electronic product. As such, the user can still view the display on the screen when the electronic product is clamped, and the lifted upper cover can provide sun-ray shielding effect to further enhance the viewing.

To achieve the aforementioned object, the present invention includes a base unit, a clamping unit, at least a stop unit and a retractable unit, wherein the base unit having a placement surface for providing placement of an electronic product, the clamping unit and the stop unit being disposed at the base unit, the clamping unit able to move towards or away from the stop unit so that the electronic product being clamped between the clamping unit and the stop unit, the retractable unit being disposed at the clamping unit, further including a retractable rod and a buckle element, the buckle element being disposed at the tip of the retractable rod, the buckle element being above the clamping unit when the retractable rod extending. As such, when the electronic product is clamped with the protective sleeve on, the buckle element can lift the upper cover of the protective sleeve.

Furthermore, another embodiment of the present invention includes a base unit, at least two clamping units and a retractable unit, wherein the base unit having a placement surface for providing placement of an electronic product, the two clamping unit being disposed at two sides of the placement surface of the base unit, one clamping unit able to move towards or away from the other clamping unit so that the electronic product being clamped between the two clamping units, the retractable unit being disposed at one of the two clamping units, further including a retractable rod and a buckle element, the buckle element being disposed at the tip of the retractable rod, the buckle element being above the clamping unit when the retractable rod extending.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the first embodiment according to the present invention;

FIG. 2 shows a schematic view of the operation of the first embodiment according to the present invention;

FIG. 3 shows a schematic view of the present invention in actual application;

FIG. 4 shows a schematic view of the second embodiment according to the present invention;

FIG. 5 shows a dissected view of the third embodiment according to the present invention; and

FIG. 6 shows a schematic view of the fourth embodiment according to the present invention.

### DETAILED DESCRIPTION OF THE PREFERRED EMBODIMENTS

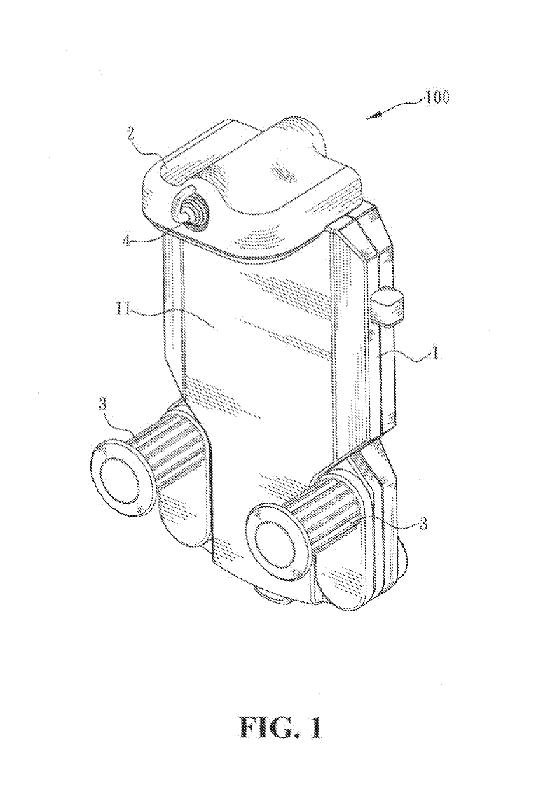

FIG. 1 shows a schematic view of the present invention. A clamping apparatus 100 of the present invention includes a base unit 1, a clamping unit 2, at least a stop unit 3 and a retractable unit 4.

The base unit 1 includes placement surface 11 for placing an electronic product. The clamping unit 2 and the stop unit 3 are disposed at the base unit 1. The clamping unit 2 can move linearly towards or away from the stop unit 3 so that the electronic product can be clamped between the clamping unit 2 and the top unit 3. The stop unit 3 can rotate to adjust the position so as to match the movable clamping unit 2 for clamping electronic products of various sizes. The present embodiment shows an illustrative embodiment of the clamping apparatus 100, instead of restricting the invention.

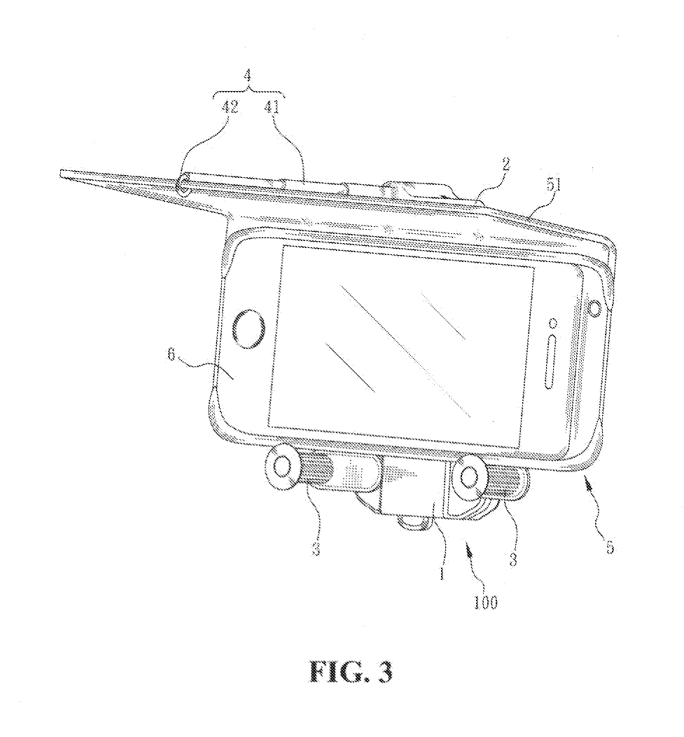

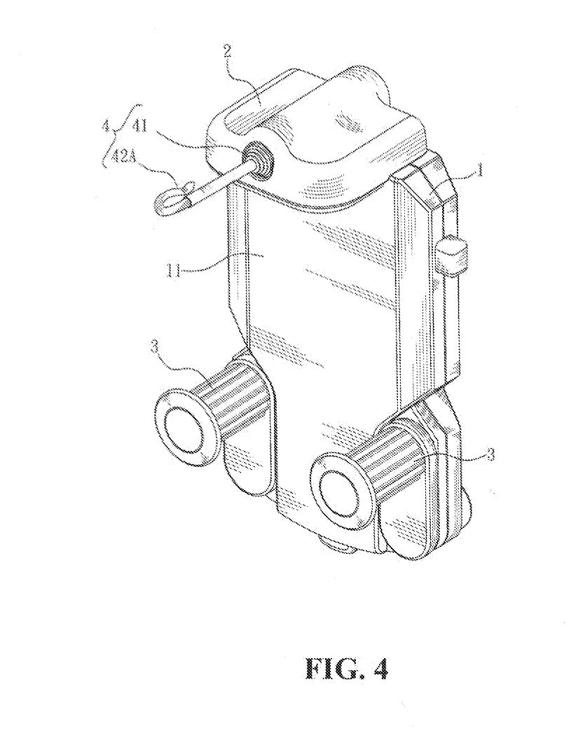

The main feature of the present invention is to include a retractable unit 4, which is disposed at the clamping unit 2. The retractable unit 4 further includes a retractable rod 41 and a buckle element 42. The buckle element 42 is disposed at the tip of the retractable rod 41. The buckle element 42 is above the clamping unit 2 when the retractable rod 41 extends. In addition, the buckle element 42 can rotate with the retractable rod 41 as an axis to adjust the orientation of the buckle element 42. The function of the buckle element 42 is to clamp or fix an edge of the upper cover 51 (as shown in FIG. 3) of a protective sleeve 5. Therefore, the shape and the structure of the buckle element 42 may vary. In the present embodiment, the buckle element 42 is a hook to hook on the upper cover 51 of the protective sleeve 5. However, the shape and the structure of the buckle element 42 is not restricted to the present embodiment. As shown in FIG. 4, the second embodiment of the present invention shows that the buckle element 42A is a clip, a bended and resilient structure to clamp and fix the upper cover 51 in place.

FIG. 3 shows a schematic view of the present invention in actual application. The electronic product 6 is sheathed inside a protective sleeve 5. The protective sleeve 5 includes an upper cover 51, able to be lifted. The electronic product 6 may be a mobile phone, which is usually covered by the protective sleeve 5 when not in use. The upper cover 51 covers the screen of the electronic product. When the electronic product 6 and the protective sleeve 5 are clamped together between the clamping unit 2 and the stop unit 3, the retractable rod 41 is extended and uses the buckle element 42 to hook on the edge of upper cover 51 so that the upper cover 51 is in a lifted position. As such, when the electronic product 6 is clamped with the protective sleeve 5 on by the clamping apparatus 100, the upper cover 51 will not block the view of the user of the display on the screen. Furthermore, the lifted upper cover 51 also provides sun-ray shielding effect.

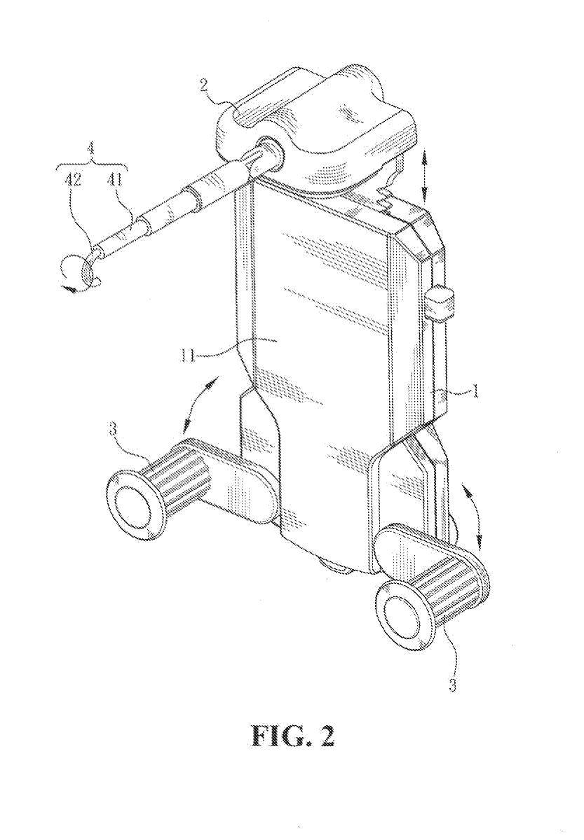

In addition, as shown in FIG. 2, when the retractable rod 41 is extended to the full length, the tip of the retractable rod 41 is coupled to the clamping unit 2. As such, the retractable rod 41 can be adjusted for various angles to adjust the lifted angle of the upper cover 51 of the protective sleeve 5.

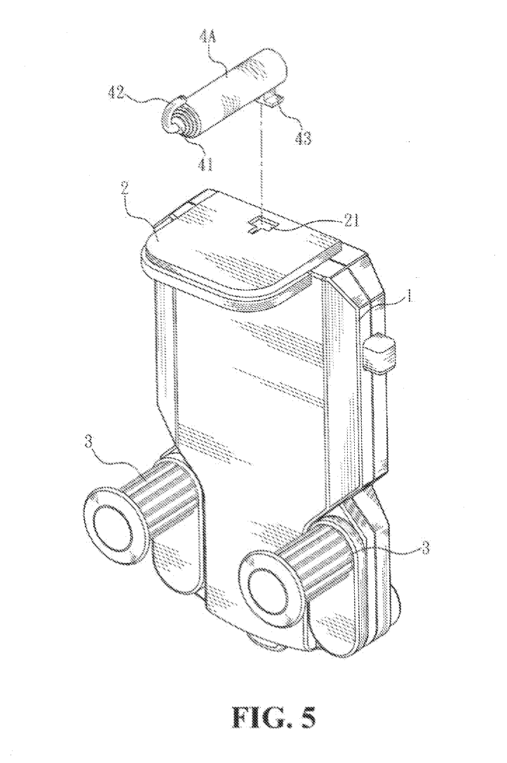

FIG. 5 shows a schematic view of the third embodiment of the present invention. In this embodiment, the retractable unit 4A is disposed at the clamping unit 2 in a detachable manner. At this point, the retractable unit 4A is disposed with protruding blocks 43 on outer wall. The clamping unit 2 includes trench 21 of specific shape at corresponding location so that the protruding block 43 and the trench 21 are buckled to engage and can be disengaged easily when not in use. However, the retractable unit 4A can also be fixed to the clamping unit 2 with glue.

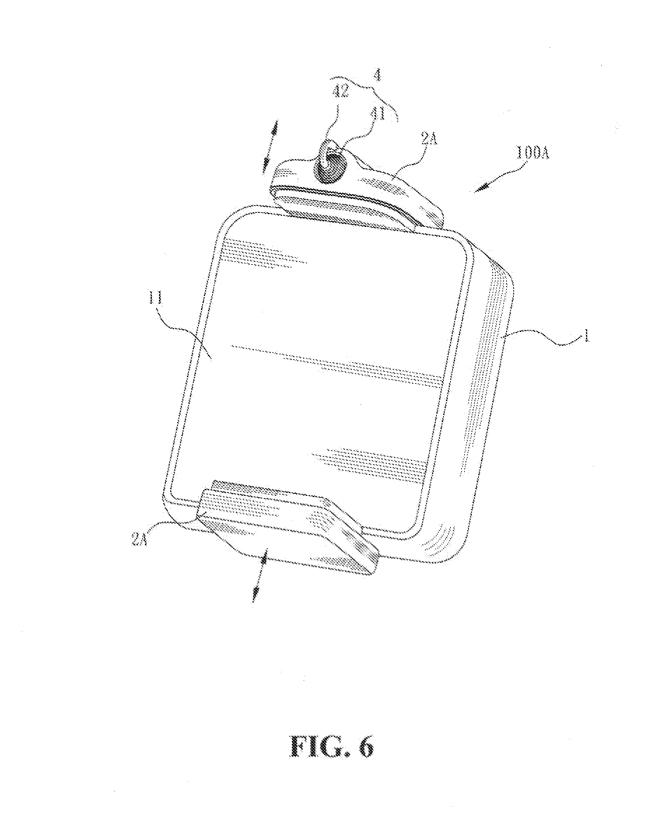

FIG. 6 shows a schematic view of the fourth embodiment of the present invention. In this embodiment, the clamping apparatus 100A mainly includes a base unit, at least two clamping units 2A and a retractable unit 4. The base unit 1 includes placement surface 11 for placing an electronic product. The two clamping units 2A are disposed at the base unit 1. The two clamping units 2A are located on two sides of the placement surface 11, with one clamping unit 2A able to move linearly towards or away from the other clamping unit 2A so that the electronic product can be clamped between the two clamping units 2A. The retractable unit 4 is disposed at one of the two clamping units 2A. The retractable unit 4 further includes a retractable rod 41 and a buckle element 42. The buckle element 42 is disposed at the tip of the retractable rod 41. The buckle element 42 is above the clamping unit 2A when the retractable rod 41 extends.

In the present embodiment, the clamping apparatus 100A has one clamping unit 2A movable linearly and the other clamping unit 2A fixed. Alternatively, the two clamping units 2A can be both be movable towards or away from each other. The retractable unit 4 can be disposed on any one of the two clamping units 2A.

In summary, the present invention includes a retractable unit in the clamping apparatus so that the retractable unit 4 can maintain the upper cover of a protective sleeve when the clamping apparatus clamps an electronic product with the protective sleeve on. The lifted upper cover provides further effect for shielding sun-ray to make viewing the display on the screen more comfortable.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A clamping apparatus, comprising a base unit, a clamping unit, at least a stop unit and a retractable unit;
wherein the base unit having a placement surface for providing placement of an electronic product;
the clamping unit and the stop unit being disposed at the base unit, the clamping unit able to move towards or away from the stop unit so that the electronic product being clamped between the clamping unit and the stop unit;
the retractable unit being disposed at the clamping unit, further comprising a retractable rod and a buckle element, the buckle element being disposed at the tip of the retractable rod, the buckle element being above the clamping unit when the retractable rod extending.

2. The clamping apparatus as claimed in claim 1, wherein the buckle element is a hook.

3. The clamping apparatus as claimed in claim 1, wherein the buckle element is a clip.

4. The clamping apparatus as claimed in claim 1, wherein the retractable unit is disposed to the clamping unit in a detachable manner.

5. The clamping apparatus e as claimed in claim 1, wherein the retractable unit is coupled to the clamping unit.

6. A clamping apparatus, comprising a base unit, at least two clamping units and a retractable unit;
wherein the base unit having a placement surface for providing placement of an electronic product;
the two clamping unit being disposed at two sides of the placement surface of the base unit, one clamping unit able to move towards or away from the other clamping unit so that the electronic product being clamped between the two clamping units;
the retractable unit being disposed at one of the two clamping units, further including a retractable rod and a buckle element, the buckle element being disposed at the tip of the retractable rod, the buckle element being above the clamping unit when the retractable rod extending.

7. The clamping apparatus as claimed in claim 6, wherein the buckle element is a hook.

8. The clamping apparatus as claimed in claim 6, wherein the buckle element is a clip.

9. The clamping apparatus as claimed in claim 6, wherein the retractable unit is disposed to the clamping unit in a detachable manner.
